(19) United States
(12) Patent Application Publication
(10) Pub. No.: US 2013/0046612 A1
(43) Pub. Date: Feb. 21, 2013

(54) ATTENTION ASSURANCE METHOD AND SYSTEM

(71) Applicants: Andrew Prihodko, Lincoln, MA (US); Sharon A. Peyer, Lincoln, MA (US); Andrew Marcuvitz, Lincoln, MA (US)

(72) Inventors: Andrew Prihodko, Lincoln, MA (US); Sharon A. Peyer, Lincoln, MA (US); Andrew Marcuvitz, Lincoln, MA (US)

(21) Appl. No.: 13/209,912

(22) Filed: Aug. 15, 2011

(51) Int. Cl. G06Q 30/00

(52) U.S. Cl. 705/14.41

(57) ABSTRACT

Systems and methods in which advertisers can be assured that target audience members for whom advertising messages are intended both receive the advertising messages, and consume the ads while paying sufficient attention to them. The system and methods can be used to present at least one ad for consumption by a target audience member at a computerized device, to detect at least one condition associated with the consumption of the ad at the computerized device, and to block or at least partially inhibit audience member access to at least one item of value associated with on-line content at the computerized device based on the condition associated with the consumption of the ad.

### CROSS REFERENCE TO RELATED APPLICATIONS

Not applicable

### STATEMENT REGARDING FEDERALLY SPONSORED RESEARCH OR DEVELOPMENT

Not applicable

### FIELD OF THE INVENTION

The present application relates generally to the field of advertising in which advertising messages are delivered to target audience members by devices that have computer intelligence, and more specifically to systems and methods of assuring that the target audience members for whom the advertising messages are intended both receive the advertising messages and pay sufficient attention to them.

### BACKGROUND OF THE INVENTION

Broadcast and cable networks have long been employed as mainstream advertising media. With the rise of data networking and the Internet, the on-line advertising medium has become increasingly important both as a way to market to burgeoning target audiences, and as a way for providers of goods and services to make money. The associated rise of network-connected intelligent devices, such as personal computers, tablets, smartphones, set-top boxes, and intelligent televisions, has enabled advertisers to be charged for their advertisements based on the contemporaneous viewing behavior of members of the target audiences rather than the target audience members' demographics or historical behaviors.

An example of charging for ads that is based at least partially on the contemporaneous viewing behavior of a target audience member is Cost Per Click (CPC) advertising on a webpage link, in which an advertiser is charged if the audience member clicks through the associated link. Another example is Cost Per Engagement (CPE) advertising, in which the advertiser is charged when the audience member has taken a voluntary action such as hovering the mouse cursor over an ad, thereby demonstrating that he or she has mentally engaged with the ad. Still another example is Cost Per View (CPV) advertising, in which the advertiser is charged when a video ad has been started by the audience member and runs substantially to its conclusion.

Ad charging schemes such as those described above suffer from drawbacks, however, in that advertisers potentially expose themselves to being charged for advertising messages that were not attentively received by the target audience members. Such drawbacks generally stem from the fact that the specific actions of the audience members that trigger such ad charging do not necessarily demonstrate that the audience members have paid sufficient attention while consuming (e.g., viewing and/or listening to) the ads. This can be particularly problematic when a value associated with the consumption of such ads is subsequently used by the audience members to pay for desired on-line information and/or entertainment content. For example, with regard to CPC advertising, an audience member may click-through to an ad and then immediately navigate away, having only barely visually processed the ad. Further, with regard to CPE advertising, the advertiser is charged when the audience member momentarily engages with an ad, without any substantial assurance that he or she is actually paying attention to the ad. For example, such an audience member may be reading unrelated material located elsewhere on the web page. Moreover, with regard to CPV advertising, advertisers are charged so long as their video ads are delivered, without knowing whether the audience member has left the room, or is conducting some simultaneous activity that is diverting his or her attention away from the ad.

In view of the overall goal of advertisers, which is to deliver their advertising messages to target audience members who pay sufficient attention as the ads are being presented to them, it would be desirable to have improved systems and methods of assuring such advertisers that target audience members have attentively consumed such ads, while avoiding at least some of the drawbacks of the known ad charging schemes described above.

### BRIEF SUMMARY OF THE INVENTION

In accordance with the present application, systems and methods are disclosed in which advertisers can be assured that target audience members for whom advertising messages are intended both receive the advertising messages, and consume (e.g., view and/or listen to) the ads while paying sufficient attention to them. Knowing the proportion of delivered advertisements that were attentively consumed by target audience members is a fundamental aspect of the economics of advertising, as the cost of a single ad impression is generally based on the value of its advertising message being successfully imparted to one or more members of the target audience. An advertising message that is ignored by a recipient audience member has essentially no value, and its cost generally represents wasted money to the advertiser. Assurance that advertising messages delivered to target audience members are attentively consumed frees advertisers from the concern that they will end up wasting money on advertisements that will be ignored. Such advertisements can be used to support (e.g., pay for) at least some of a target audience member's desired on-line information content and/or entertainment content, so when an advertisement is ignored or avoided by the audience member, he or she is often viewed by content publishers as being unfairly rewarded with access to on-line content, and by advertisers as unfairly incurring ad charges. The presently disclosed systems and methods provide an improved basis for both accurately charging advertisers for delivering their advertisements to target audience members, and fairly rewarding the target audience members for paying sufficient attention to such advertisements.

The presently disclosed systems and methods are based on what is referred to herein as Cost Per Attentive View (CPAV) advertising, which can be applicable to video ads, multimedia ads, animated ads, audio ads, static text/image ads, or any other suitable advertising messages. Because CPAV advertising addresses the advertisers' goal of having their advertising messages attentively consumed by target audience members, it represents a substantial improvement to the advertising process, enabling the advertisers to be charged only for ads that are attentively consumed (e.g., viewed and/or listened to) by the target audience members. Such an attention assurance feature of CPAV advertising can also increase the value of each advertising message, and can therefore be beneficial to ad publishers who may wish to charge advertisers an increased amount for each ad that the advertisers successfully deliver to their target audience members.

In accordance with the presently disclosed systems and methods, the advertising messages that target audience members receive can be used to pay for the cost of the on-line information content and/or entertainment content desired by the respective audience members. Such on-line information/entertainment content effectively serves as the target audience members' reward for viewing and/or listening to the advertising messages. Recent technological advances have provided such audience members with various ways of avoiding ads, which are inadequately addressed by existing ad charging schemes. For example, multi-processing, multi-windowing, sound muting/lowering, and digital video recording (DVR) fast-forward features, among others, are obstacles to advertisers being able to determine whether or not their advertising messages were successfully received and consumed by the audience members. The presently disclosed systems and methods can overcome such obstacles by using the intelligence of a content receiving device to observe the behavior of the audience members, and to determine whether such behavior is consistent with a desired level of viewing/listening attentiveness. The disclosed systems and methods can employ such observations of audience member behavior as a basis for charging the advertisers and/or for rewarding the target audience members. The disclosed systems and methods can also use such observations to enhance the attentiveness of the target audience members.

More specifically, the presently disclosed systems and methods can provide advertisers with enhanced attention assurance for advertisements that are delivered through a network to devices with computer intelligence associated with the target audience members. The disclosed systems and methods can be used to implement, at each audience member device, at least one first process (such first process also referred to herein as the “ad avoidance detector”) operative to observe the behavior of a target audience member by monitoring one or more inputs to detect user interactions with the device that suggest some level of ad avoidance. For example, at least one or more of the following ad avoidance conditions can be recognized by the ad avoidance detector as suggesting that the audience member is avoiding and/or at least not attentively viewing/listening to an advertisement currently being presented at his or her device:

(i) The audience member switches focus from a graphical display window on a device display in which an advertisement is being presented to a different graphical display window on the device display;

(ii) The audience member minimizes a graphical display window in which an advertisement is being presented;

(iii) The audience member switches between a first browser tab corresponding to a web page in which an advertisement is being presented to a different browser tab;

(iv) The audience member resizes a graphical display window in which an advertisement is being presented below a minimum resolution of an associated ad player application;

(v) The audience member drags some portion of a graphical display window in which an advertisement is being presented off the display screen;

(vi) The audience member lowers or mutes the volume for the ad player application, and/or the volume associated with the device itself;

(vii) The audience member is visually observed to be not present;

(viii) The audience member is visually observed to be motionless, e.g., possibly asleep;

(ix) The audience member is visually observed to be not looking at the display screen; and

(x) The ambient noise level is aurally observed to be too high for the advertising message to be clearly heard and understood by the audience member.

When one or more such ad avoidance conditions are detected, playback of the ad can be suspended until such conditions no longer exist. Further, information pertaining to such ad avoidance conditions can be reported by the ad avoidance detector over the network to an ad charging server, which can use such information in determining an appropriate charge, if any, to the advertiser.

The presently disclosed systems and methods can also be used to implement, at each audience member device, at least one additional process (such additional process also referred to herein as the “user inattention detector”) operative to monitor user interactions with the audience member device, thereby determining whether the audience member is no longer paying sufficient attention to the advertisement, or possibly is no longer present. When such user interaction with the device, or lack thereof, suggests that the audience member is not paying sufficient attention to the advertising message, at least one challenge message can be issued by the user inattention detector, requesting that the audience member acknowledge that he or she is actually paying attention by providing at least one specific response. If the audience member provides the requested response within a predetermined time interval, then the audience member has demonstrated that he or she has understood the request, and is therefore likely to have been paying sufficient attention to the advertising message(s) directed to him or her at the audience member device. For example, playback of the ad can be suspended, or the ad can be removed or blacked out, until the audience member provides confirmation that he or she has resumed paying attention by interacting in a specified qualifying manner with the audience member device. Information pertaining to such user interactions can also be reported to the ad charging server for the purpose of determining an appropriate charge to the advertiser.

It is noted that, when an ad avoidance condition or user inattention is detected at the audience member device, the audience member's reward for attentively consuming an advertising message may be at least partially and/or temporarily blocked, inhibited, or withheld. It should be understood that such a reward can take the form of rights to access content, the content itself, a predetermined monetary amount, a predetermined amount of virtual currency, one or more coupons, or any other suitable item(s) of value that can be delivered to the audience member over the network to the audience member device. When the ad avoidance detector or the user inattention detector executing on an audience member device detects user interactions with the device that suggest the audience member has resumed attentively consuming advertising messages, any withholding of rewards previously imposed may end, in accordance with an adaptive method for determining a level of trust to be accorded based on the audience member's recent history of ad avoidance and/or attentiveness. For example, an audience member who has previously been attentive may be given more leeway to be inattentive before any withholding of rewards is triggered, as compared to another audience member who has recently been demonstrating significant inattentiveness. In this way, a threshold for the detection of ad avoidance and/or ad attentiveness can be established that is an adaptive function of the level of trust that the audience member has earned based at least in part on his or her most recent behavior.

Other features, functions, and aspects of the invention will be evident from the Detailed Description of the Invention that follows.

### BRIEF DESCRIPTION OF THE SEVERAL VIEWS OF THE DRAWINGS

The invention will be more fully understood with reference to the following Detailed Description of the Invention in conjunction with the drawings of which:

FIG. 1 is a schematic diagram of an attention assurance system, according to the present application;

FIG. 2a is a schematic diagram illustrating an exemplary information flow associated with an intelligent user device included in the system of FIG. 1;

FIG. 2b is a block diagram illustrating an attention assurance client software component implemented within the intelligent user device of FIGS. 1 and 2a;

FIG. 3 is an exemplary display screen associated with the intelligent user device of FIGS. 1 and 2a, illustrating an ad avoidance condition that involves switching focus between two graphical display windows;

FIG. 4 is an exemplary display screen associated with the intelligent user device of FIGS. 1 and 2a, illustrating an ad avoidance condition that involves minimizing a graphical display window in which an advertisement is being presented;

FIG. 5 is an exemplary display screen associated with the intelligent user device of FIGS. 1 and 2a, illustrating an ad avoidance condition that involves switching between browser tabs;

FIG. 6 is an exemplary display screen associated with the intelligent user device of FIGS. 1 and 2a, illustrating an ad avoidance condition that involves resizing a graphical display window in which an advertisement is being presented;

FIG. 7 is an exemplary display screen associated with the intelligent user device of FIGS. 1 and 2a, illustrating an ad avoidance condition that involves dragging a graphical display window in which an advertisement is being presented at least partially off the display screen;

FIG. 8 is an exemplary display screen associated with the intelligent user device of FIGS. 1 and 2a, illustrating an ad avoidance condition that involves muting or lowering the volume associated with an ad player application;

FIG. 9 is schematic diagram illustrating an ad avoidance condition that involves an observation that a target audience member is not present to view an advertisement at the intelligent user device of FIGS. 1 and 2a;

FIG. 10 is a schematic diagram illustrating an ad avoidance condition that involves an observation that a target audience member is motionless, e.g., possibly asleep, and therefore incapable of viewing an advertisement at the intelligent user device of FIGS. 1 and 2a;

FIG. 11 is a schematic diagram illustrating an ad avoidance condition that involves an observation that a target audience member is looking away from the intelligent user device of FIGS. 1 and 2a, and therefore incapable of viewing an advertisement at the intelligent user device;

FIG. 12 is a schematic diagram illustrating an ad avoidance condition that involves an observation that the ambient noise level is too high, thereby making it difficult for a target audience member to hear and understand an advertisement at the intelligent user device of FIGS. 1 and 2a;

FIG. 13 is an exemplary display screen associated with the intelligent user device of FIGS. 1 and 2a, illustrating the detection of a user inattentiveness condition by issuing an “Are You Still There?” (AYST) challenge message; and

FIG. 14 is a flow diagram illustrating an exemplary method of adaptive user inattention detection, which can be implemented at the intelligent user device of FIGS. 1 and 2a.

### DETAILED DESCRIPTION OF THE INVENTION

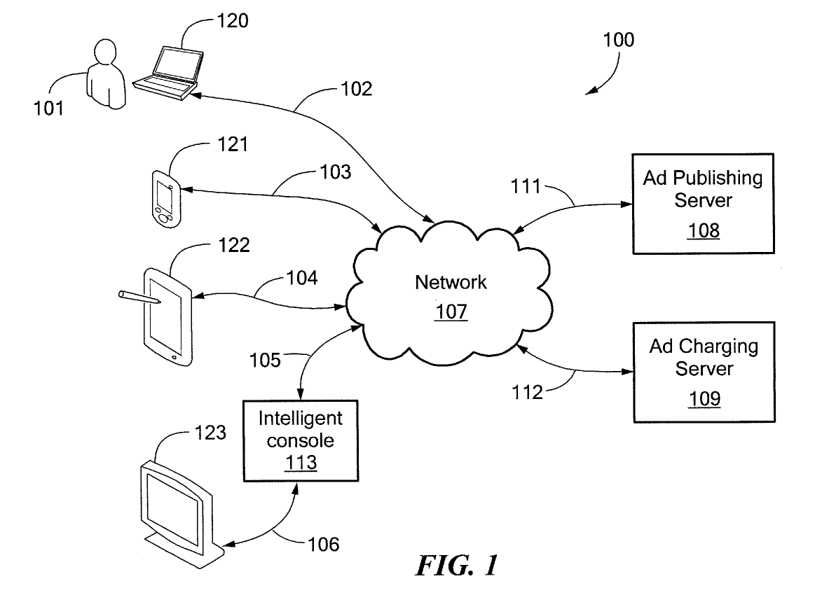

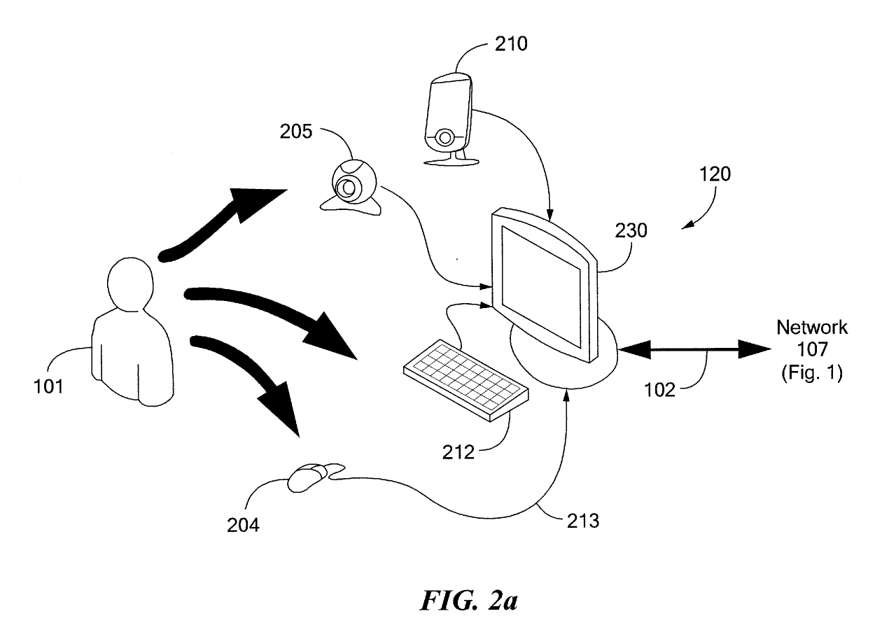

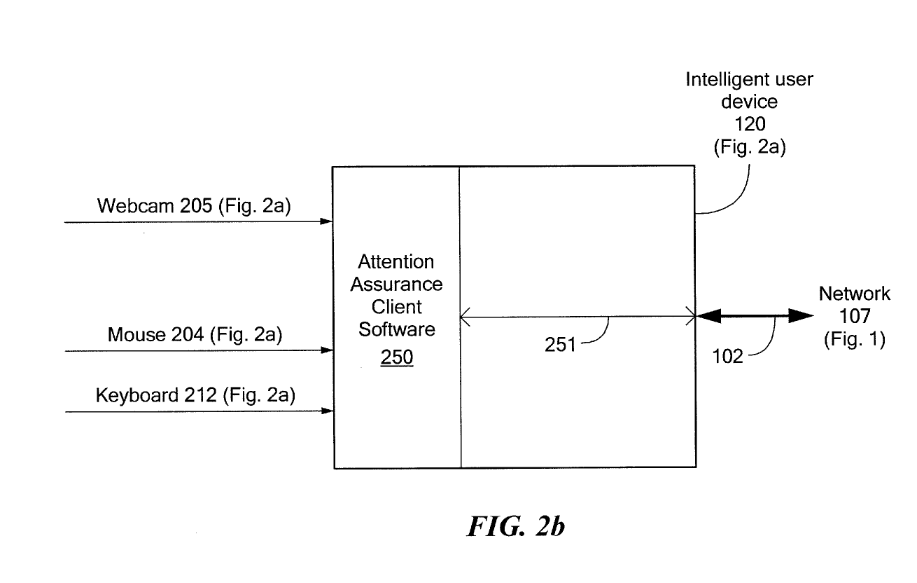

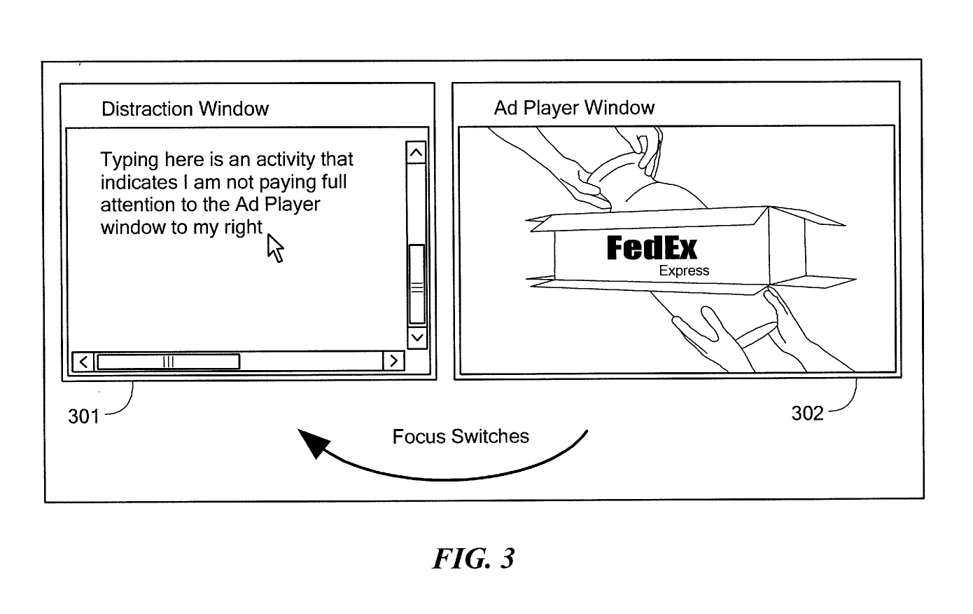

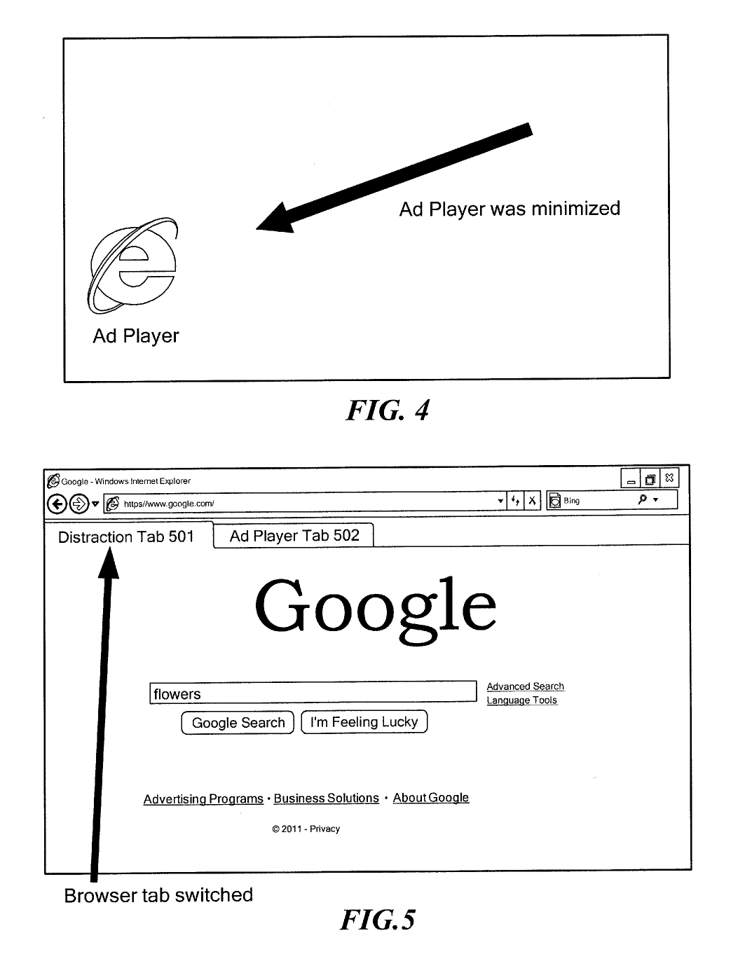

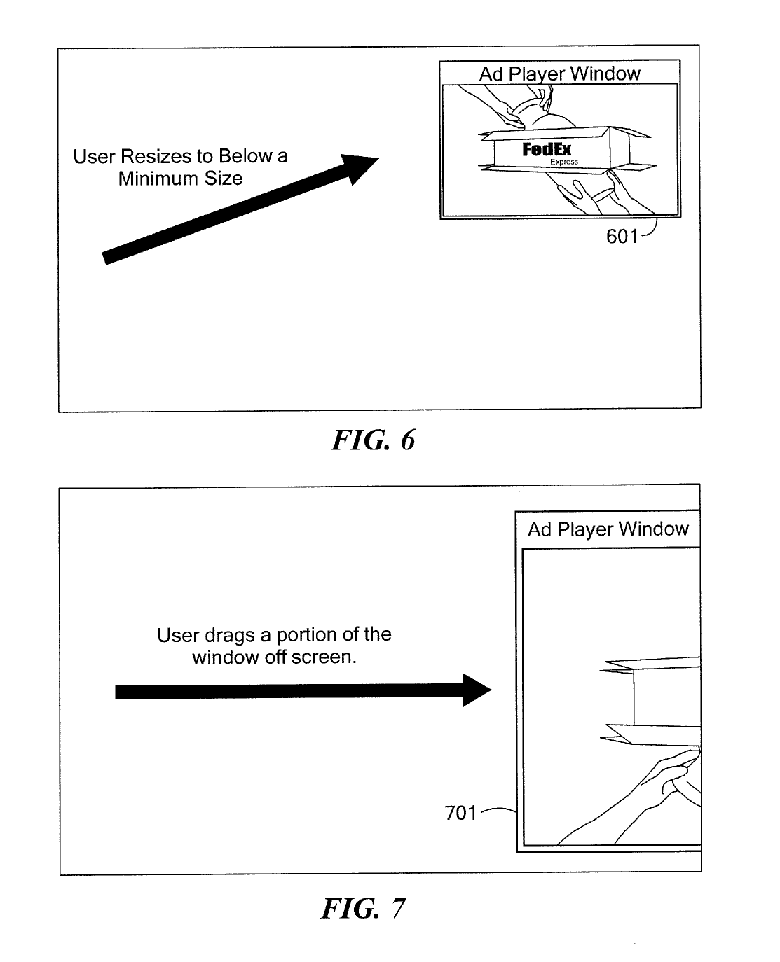

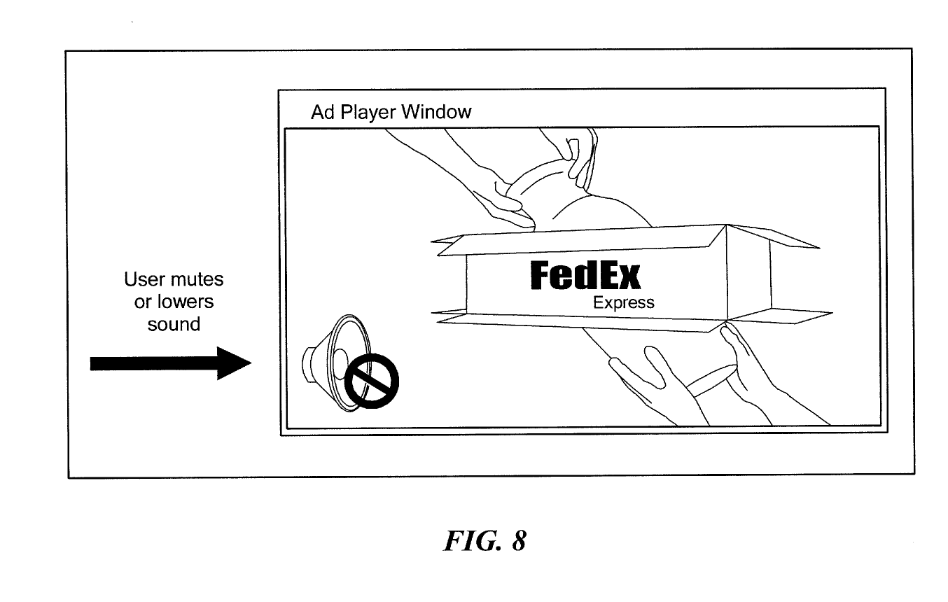

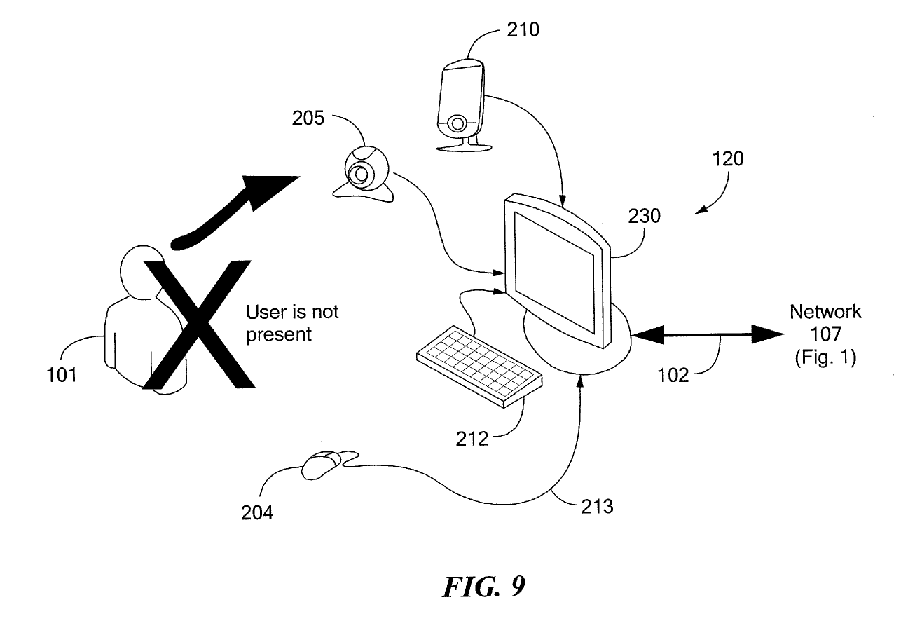

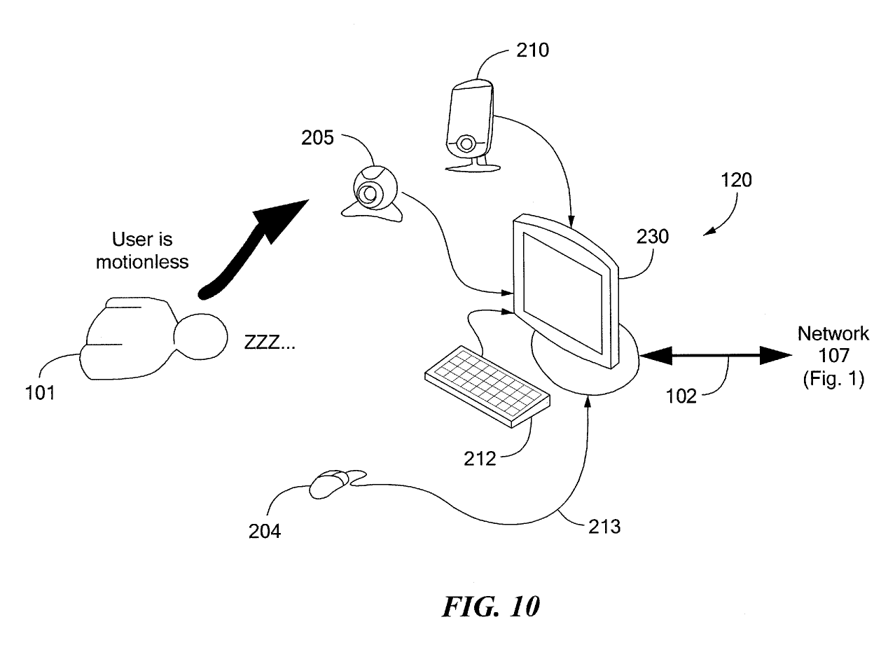

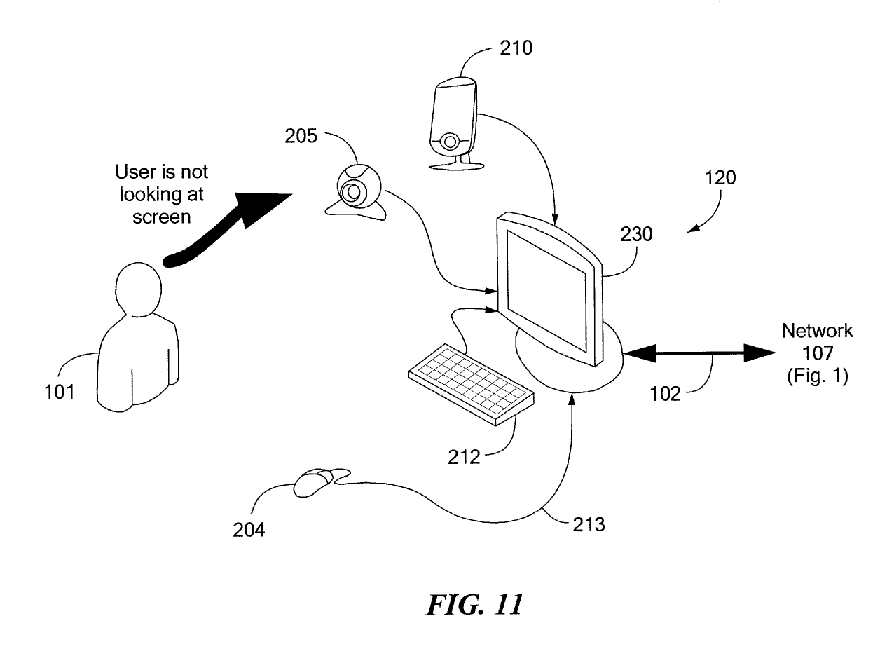

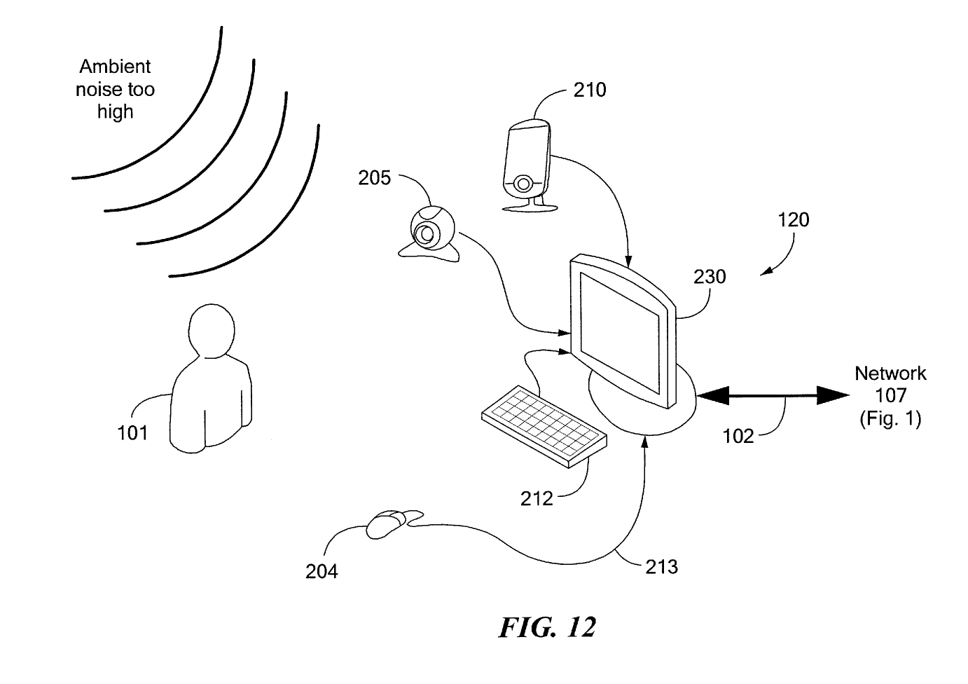

FIG. 1 depicts an illustrative embodiment of a system 100 for assuring advertisers that target audience members have attentively consumed their advertising messages (such system also referred to herein as the “attention assurance system”), in accordance with the present application. As employed herein, the term “ad” is used interchangeably with the terms “advertisement” and “advertising message”.

As shown in FIG. 1, the attention assurance system 100 includes a computerized user device 120, which is communicably coupled to a network 107 by a communications path 102. The network 107 provides a mechanism for allowing communication between the computerized user device 120, at least one ad publishing server 108, and at least one ad charging server 109, as depicted in FIG. 1. For example, the network 107 can be a local area network (LAN), a wide area network (WAN), a wireless network, an Intranet, the Internet, a private network, a public network, a switched network, or any other suitable communication network, including any suitable combination and/or variation thereof. Further, various communication protocols may be employed to facilitate communication of information over the network 107, including TCP/IP, HTTP, XML, WAP, or any other suitable protocol. A user 101 (such user also referred to herein as an/the “audience member”) can provide one or more inputs to the computerized user device 120, and can receive audio and/or visual outputs from the computerized user device 120. For example, the audience member 101 can receive, at the computerized user device 120, one or more advertisements from the ad publishing server 108 over a communications path 111, the network 107, and the communications path 102. Further, the communications paths communicably coupling the respective devices to the network 107 can be wire-based, optical fiber-based, cloud-based, wireless, or any suitable combination and/or variation thereof.

In accordance with the illustrative embodiment of FIG. 1, the computerized user device 120 can include one or more computers having one or more processors operative to execute one or more software programs out of at least one memory for implementing the functionality of the attention assurance system 100. One or more of such processors are operative to execute attention assurance client software 250 (see FIG. 2b) for use in observing the audience member's interactions with the computerized user device 120 while an advertising message is being presented at the device 120, and in making determinations as to whether or not the advertising message was attentively consumed (e.g., viewed and/or listened to) by the audience member 101. If the attention assurance client software 250 determines that the ad was attentively consumed by the audience member 101, the computerized user device 120 can send at least one notification to the ad charging server 109 over the communications path 102, the network 107, and a communications path 112. In response to such a notification, the ad charging server 109 is operative to charge an advertiser for the advertisement based at least in part on the observed attentive consumption of the advertisement by the audience member 101.

It is noted that any other suitable computerized user device(s) with computer intelligence and bi-directional network connection capabilities may be employed in conjunction with the attention assurance client software 250, either in place of or in addition to the computerized user device 120. Such computerized user device(s) can include, but are not limited to, a smartphone 121, a tablet computer 104, and a television 123. For example, the smartphone 121 and the tablet computer 104 are communicably coupleable to the network 107 by a communications path 103 and a communications path 104, respectively. Further, the television 123 is communicably coupleable to the network 107 by communications paths 105, 106 through an intelligent console 113, which can be implemented as any suitable intelligent device that can receive input from the audience member 101 and communicate bi-directionally over the network 107. For example, the intelligent console 113 may be a game console, a streaming set-top box, a cable set-top box, or any other suitable device. In some cases, the intelligent console 113 can be integrated into the television 123. It is further noted that electronic paper displays and/or intelligent digital signs may also be employed in conjunction with the attention assurance client software 250. Moreover, computerized audio-only devices with bi-directional network connection capabilities may be employed in conjunction with the attention assurance client software 250 in the context of providing audio-only functionality.

FIG. 2a depicts an illustrative embodiment of the computerized user device 120 implemented as a personal computer. It should be noted, however, that the computerized user device 120 can be implemented as any other suitable device having inputs that permit the observation of user behavior. As shown in FIG. 2a, the computerized user device 120 includes a plurality of input devices such as a keyboard 212, a mouse 204, and a webcam 205 which typically includes a video camera and a microphone. The audience member 101 can consume (e.g., view and/or listen to) advertising messages received at the computerized user device 120 over the communications path 102 and the network 107, using a computer display 230 and/or a speaker 210.

FIG. 2b depicts a conceptual view of the attention assurance client software 250 residing within the computerized user device 120. For example, by executing the attention assurance client software 250, the computerized user device 120 can effectively observe user behavior by analyzing any or all of the user inputs that are available through the keyboard 212, the mouse 204, and/or the webcam 205. The attention assurance client software 250 allows the computerized user device 120 to observe such user behavior by processing the user inputs independently of, and/or in addition to, any other resident software within the computerized user device 120, and to communicate its ad avoidance and inattention determinations over the network 107 through the communications path 102. In an alternative embodiment, one or more user input interaction sequences may be relayed over the network 107 from the computerized user device 120 to an external server (not shown), which can perform attention assurance functions on behalf of one or more computerized user devices.

In accordance with the illustrative embodiments of FIGS. 1, 2a, and 2b, the attention assurance system 100 is operative to perform at least some of the attention assurance functions by detecting one or more ad avoidance conditions. For example, such ad avoidance conditions can typically occur when the audience member 101 interacts with the computerized user device 120 in such a way that permits him or her to perform tasks other than attentively consuming an advertising message, and/or to suppress the full presentation of the ad on the computerized user device 120. One or more of the processors within the computerized user device 120 are operative to execute the attention assurance client software 250 for detecting such ad avoidance conditions. For example, the attention assurance client software 250 can detect such ad avoidance conditions by using an application programming interface (API) provided by any suitable operating system (e.g., Windows™, Linux™, OSX™, Unix™, etc.), any suitable browser (e.g., Internet Explorer™Safari™, Firefox™, etc.), and/or any suitable ad player application platform (e.g., Adobe Flash™) to monitor the state of the computerized user device 120 with respect to the placement, size, focus, etc., of any graphical display windows displayed on the computer display 230. Further, a programmed inquiry and/or a received event may be employed to determine whether or not there have been any state changes indicative of such ad avoidance conditions.

FIG. 3 depicts one such ad avoidance condition, in which the audience member switches the window focus from an ad player window 302 in which an advertisement is being presented to another window 301 on the computerized user device, thereby directing subsequent window system input events away from the window 302 presenting the ad. Such an ad avoidance condition may occur if the audience member were to switch to an activity unrelated to consuming (e.g., viewing and/or listening to) the ad in the window 302, such as checking his or her email messages using the other window 301. For example, the attention assurance client software 250 (see FIG. 2b) may detect such an ad avoidance condition by using an appropriate API to inquire whether the ad player window 302 no longer has focus.

FIG. 4 depicts another ad avoidance condition in which the audience member minimizes an ad player window in which an advertisement is being presented, so that the visual presentation of the advertising message is avoided. Such an ad avoidance condition may occur if the audience member redirects his or her attention to a computer display activity other than consuming the ad. For example, the attention assurance client software 250 (see FIG. 2b) may detect such an ad avoidance condition by using the appropriate API to inquire whether or not the ad player window is in a minimized state.

FIG. 5 depicts still another ad avoidance condition in which the audience member switches from an ad player browser tab 502 associated with the presentation of an advertisement to another browser tab 501 (such browser tab also referred to herein as the “distraction tab”), thereby avoiding the visual presentation of the advertising message in favor of the newly active distraction tab 501. Such an ad avoidance condition may occur if the audience member chooses to redirect his or her attention to a browser tab other than that associated with the advertisement. For example, the attention assurance client software 250 (see FIG. 2b) may detect such an ad avoidance condition by using the appropriate API to inquire whether ad content associated with the ad player tab 502 is visible or hidden on the computer display.

FIG. 6 depicts yet another ad avoidance condition in which the audience member resizes an ad player window 601 in which an advertisement is being presented to a size that is below a predetermined minimum resolution required to permit adequate visual presentation of the advertising message. For example, the attention assurance client software 250 (see FIG. 2b) may detect such an ad avoidance condition by using the appropriate API to inquire the dimensions (e.g., the width and/or the height) of the ad player window 601. If the width and/or the height of the ad player window 601 do not meet predetermined qualifying thresholds, then it is determined that the ad avoidance condition of FIG. 6 exists.

FIG. 7 depicts still yet another ad avoidance condition in which the audience member drags an ad player window 701 in which an advertisement is being presented at least partially off the computer display, obscuring the visual presentation of the ad. For example, the attention assurance client software 250 (see FIG. 2b) may detect such an ad avoidance condition by using the appropriate API to inquire the dimensions (e.g., the width and/or the height) of the computer display and the ad player window 701, and to inquire the location of the origin of the ad player window 701. Such information can be used to determine the portion(s) of the width and/or the height of the ad player window 701 that are visible on the computer display, if any. If such portions of the width and/or the height of the ad player window 701 do not meet predetermined qualifying thresholds, then it is determined that the ad avoidance condition of FIG. 7 exists.

FIG. 8 depicts a further ad avoidance condition in which the audience member lowers or mutes the volume for the ad player application, and/or the volume associated with the computerized user device itself, below a predetermined threshold, thereby inhibiting the aural presentation of an advertising message. For example, the attention assurance client software 250 (see FIG. 2b) may detect such an ad avoidance condition by using the appropriate API to inquire what the system and/or application volume level are set to, and/or whether or not the system audio has been muted. If such settings do not meet predetermined qualifying threshold, then it is determined that the ad avoidance condition of FIG. 8 exists.

FIG. 9 depicts an ad avoidance condition in which an analysis of the video input from the webcam 205 is used to determine whether or not the audience member 101 is present within the webcam's field of view. During playback of an advertising message on the computerized user device 120 by the ad player application, the attention assurance client software 250 processes video from the webcam 205 using pattern recognition techniques known to those of ordinary skill in the art, such as the pattern recognition techniques described in the publication of T. Darrell, G. Gordon, M. Harville, and J. Woodfill, “Integrated Person Tracking Using Stereo, Color, and Pattern Detection”, International Journal of Computer Vision 37(2), 2000, pages 175-185. Specifically, the attention assurance client software 250 can process video from the webcam 205 to analyze the image field to identify shapes potentially indicative the presence of the audience member 101 inside a region of the field of view of the camera from which the ad can be consumed. For example, if no predetermined qualifying shape(s) indicative of a human are identified within a predetermined time period, then it is determined that the ad avoidance condition of FIG. 9 exists.

FIG. 10 depicts another ad avoidance condition in which the video input provided by the webcam 205 is analyzed to determine whether a level of motion within the webcam's field of view is below a predetermined level indicative of an attentive audience member 101. During playback of an advertising message on the computerized user device 120 by the ad player application, the attention assurance client software 250 (see FIG. 2b) processes the video from the webcam 205 using motion detection techniques known to those of ordinary skill in the art, such as the motion detection techniques described in the publication of Ramprasad Polana and Randal C. Nelson, “Recognition of Motion from Temporal Texture”, Proceedings of IEEE Conference on Computer Vision and Pattern Recognition, 1992, pages 129-134. Specifically, the attention assurance client software 250 can process the video from the webcam 205 to analyze the image field to detect a minimum level of movement over a predetermined time period that would be indicative of an attentive audience member, as distinguished from an audience member avoiding an ad. For example, such an audience member may be asleep. Further, successive frames in the video may be compared for differences indicative of the motion of an attentive audience member within the image field. If a predetermined qualifying level of image differences is not detected, then it is determined that the ad avoidance condition of FIG. 10 exists.

FIG. 11 depicts still another ad avoidance condition in which the video input from the webcam 205 is analyzed to determine whether or not the audience member 101 is looking in the direction of the computer display 230, thereby determining whether or not visual presentation of the advertising message on the computer display 230 to the audience member is being successfully accomplished. During playback of the advertising message by the ad player application, the attention assurance client software 250 (see FIG. 2b) processes the video from the webcam 205 using facial recognition techniques known to those of ordinary skill in the art, such as the facial recognition techniques described in the publication of Qiong Wang and Jingyu Yang, “Eye Detection in Facial Images with Unconstrained Background”, Journal of Pattern Recognition Research 1, 2006, pages 55-62. Specifically, the attention assurance client software 250 can process the video from the webcam 205 to analyze the image field to determine whether the face of the audience member 101 is detected and directed toward the computer display 230. For example, if no face with both eyes visible is recognized during a predetermined time period, allowing for normal attentive user movement, then it is determined that the ad avoidance condition of FIG. 11 exists.

FIG. 12 depicts yet another ad avoidance condition in which the microphone input from the webcam 205 is analyzed to determine whether a level of ambient sound is above a predetermined threshold indicative of conditions where aural presentation of the advertizing message would possibly be compromised. During playback of an advertising message on the computerized user device 120 by the ad player application, the attention assurance client software 250 (see FIG. 2b) processes audio from the microphone input, using audio processing techniques known to those of ordinary skill in the art, to detect ambient sound levels that may be high enough to interfere with the presentation of the ad. For example, an audio waveform received by the webcam microphone may include ambient noises in addition to audio output associated with the ad. In order to detect just the ambient sound level, the known audio waveform produced by the ad player application can be removed or cancelled from the received audio waveform, using waveform cancellation techniques known to those of ordinary skill in the art. If the resulting audio waveform represents an ambient noise level that is above a predetermined qualifying threshold, then it is determined that the ad avoidance condition of FIG. 12 exists.

Those of ordinary skill in the art will further appreciate that variations to and refinements of the exemplary techniques for detecting ad avoidance conditions described above are possible, depending at least on the API services supported by the computerized user device 120 and/or the competing objectives of complexity, speed, and accuracy.

As described above, the attention assurance system 100 is operative to perform at least some attention assurance functions by detecting one or more ad avoidance conditions. In accordance with the illustrative embodiments of FIGS. 1, 2a, and 2b, the attention assurance system 100 is further operative to perform at least some attention assurance functions by detecting user inattentiveness. For example, in response to the absence of any user input within a predetermined time period, or at any other suitable time(s), the computerized user device 120 executing the attention assurance client software 250 can present (e.g., periodically) a challenge message to the audience member 101 that calls for at least one specified user action, and determines whether or not any predetermined qualifying user responses are received and/or detected. When the audience member 101 provides such a predetermined qualifying response, the audience member 101 demonstrates a level of attentiveness by virtue of his or her understanding of the challenge message, and his or her action(s) performed in response to the challenge message.

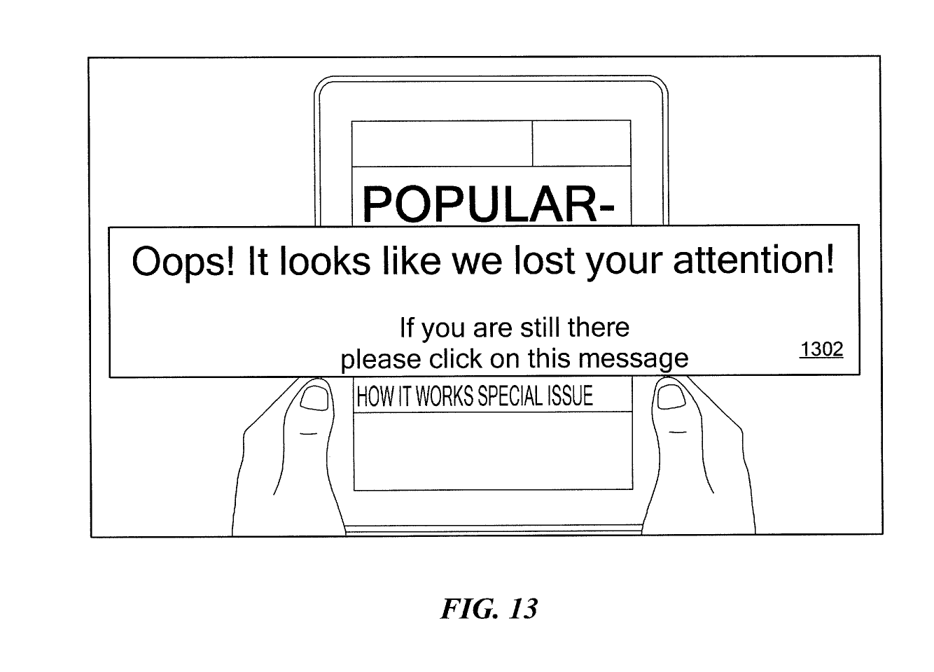

FIG. 13 depicts an illustrative example of user inattention detection, in which a visual request is made to the audience member (e.g., “Oops! It looks like we lost your attention! If you are still there please click on this message”) to demonstrate his or her attentiveness by interacting with at least one challenge message, such as a so-called “Are You Still There?” (AYST) message 1302. In accordance with the illustrative example of FIG. 13, the audience member is determined to be inattentive unless a predetermined qualifying response is received from the audience member within a predetermined time period. For example, the audience member 101 may be called upon to click on the AYST message 1302 using the mouse 204, and/or to press a key on the keyboard 212, within a predetermined time period, e.g., 5 seconds.

In order to address the conflicting objectives of providing quick detection of user inattention and avoiding annoying disruptions to the overall user experience, the AYST message 1302 can be incorporated into an adaptive user inattention detection method, which can gradually become more aggressive by increasing the frequency of challenge messages presented to the audience member if he or she has a recent history of inattentiveness. Such an adaptive user inattention detection method can also gradually become more trusting of the audience member by decreasing the frequency of challenge messages presented to the audience member, if he or she has a recent history of successful responses to such challenge messages. In this way, the adaptive user inattention detection method can provide an incentive for the audience member to maintain his or her attentiveness, thereby reducing the frequency of challenge messages to which he or she is called upon respond.

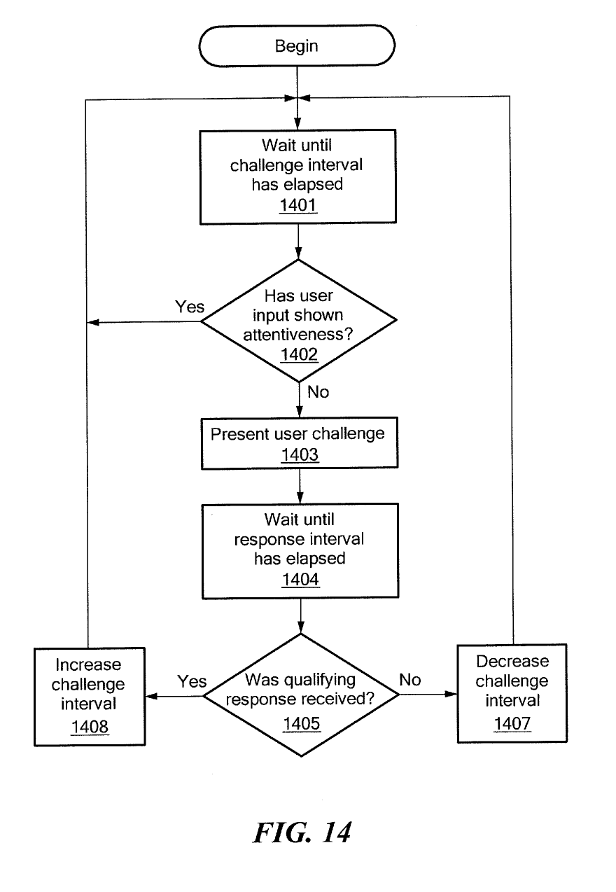

FIG. 14 depicts an illustrative adaptive user inattention detection method that employs a challenge message, such as an “Are You Still There?” (AYST) message. In this illustrative method, the audience member is also referred to as the “user”. As depicted in step 1401, a predetermined challenge interval is allowed to elapse. Such a challenge interval corresponds to a predetermined time period between individual checks of user attentiveness, and thus represents a level of aggressiveness of the adaptive user inattention detection method. As depicted in step 1402, a determination is made as to whether or not, since the last check of user attentiveness, at least one user input has been received, demonstrating that the user has been present and attentive during at least part of the challenge interval. For example, if the user increased the sound volume during playback of an advertising message on the computerized user device, or rewound back to an earlier part of the ad, then it may be determined that the user has demonstrated attentiveness during the challenge interval. In the event the user demonstrated attentiveness during the challenge interval, the method loops back to step 1401, in which the challenge interval is again allowed to elapse. In the event no user inputs have been received at the computerized user device showing that the user is present and attentive, then the user is presented with a challenge message, as depicted in step 1403, requesting the user to demonstrate, by at least one specified user input, that he or she is present and paying attention to the playback of the ad. As depicted in step 1404, a predetermined response interval is allowed to elapse, during which the user is provided with time to comprehend the request and to act upon it by providing the specified user input. As depicted in step 1405, a determination is made as to whether or not a predetermined qualifying response has been received from the user. In the event such a qualifying response has been received from the user, the user has effectively demonstrated that he or she is present and attentive, and therefore the challenge interval is increased, as depicted in step 1408, so as to disturb the user less frequently to check on his or her attentiveness. The method then loops back to step 1401. In the event such a qualifying response has not been received from the user, the user is determined to be either not present or inattentive, and therefore the challenge interval is decreased, as depicted in step 1407, so as to increase the frequency of attentiveness checks to which the user will be subjected. The method then loops back to step 1401. In this illustrative method, the challenge interval can be adjusted subject to predetermined maximum and/or minimum lengths. Further, attentive users can earn trust and be rewarded with less frequent disruptive checks on their attentiveness, while inattentive users can lose trust and be penalized with more frequent checks on their attentiveness so as to catch inattentiveness on the part of such users more quickly.

Those of ordinary skill in the art will appreciate that variations to and refinements of the exemplary techniques for detecting user inattentiveness described above are possible in order to satisfy the specific needs of users and/or advertisers.

It is noted that when an ad avoidance condition and/or a user inattentiveness condition are detected by the attention assurance client software 250 (see FIG. 2b) executing on the computerized user device 120 (see FIG. 1), one or more actions can be taken based on an ad charging scheme prearranged with the advertiser, and/or a predetermined strategy used to induce user attentiveness. Such actions can pertain to the advertiser, and can be directed toward appropriately charging for the presentation of an advertising message on a CPAV basis. Such actions can also pertain to the audience member, and be directed toward inducing him or her to be more attentive during playback of an ad. For example, an ad charging scheme in which the advertiser is charged only when an advertising message is deemed to have been attentively consumed by the audience member benefits the advertiser, who obtains a more accurate accounting of how many audience members received the advertising message, and increased confidence that the ad for which they have been charged has not been wasted on inattentive audience members. In addition, if, for example, user attention cannot be assured, then presentation of the ad can be paused until such user attention is detected, and subsequently restarted so as to increase the likelihood that the advertising message will eventually be delivered to an attentive audience member. Such an audience member can also be provided with increased incentive to be attentive during playback of an ad by blocking or at least partially inhibiting the audience member's access to any desired entertainment content or other information content whose cost is intended to be covered by the consumption of the ad.

The attention assurance systems and methods described herein generally provide the capability of detecting conditions that are inconsistent with user attentiveness during ad presentation by contemporaneously observing user input interactions with a computerized user device while such ads are being presented on the device. Although such capability is described herein as residing within the computerized user device 120 (see FIGS. 1, 2a, and 2b), in one or more alternative embodiments, such capability can reside within one or more server computers, communicably coupled to the network 107 (see FIG. 1), and operative to observe and analyze user input interactions while ads are being presented on one or more computerized user devices communicably coupled to the network 107. It should be understood that the advertisements to which the presently disclosed attention assurance systems and methods apply can include all types of ads presentable by a computerized user device, including, but not limited to, video ads, audio ads, static ads, interactive ads, banner ads, animated ads, etc.

Moreover, unlike known CPC, CPA, and CPV charging schemes which generally seek to impute user attention by virtue of the detection of at least one user action, the attention assurance systems and methods described herein generally demonstrate user attentiveness by confirming the existence or absence of certain ad avoidance conditions that are inconsistent with such user attentiveness, and confirming the existence or absence of such user inattentiveness conditions through at least one challenge message/user response sequence.

It will be appreciated by those of ordinary skill in the art that modifications to and variations of the above-described systems and methods may be made without departing from the inventive concepts disclosed herein. Accordingly, the invention should not be viewed as limited except as by the scope and spirit of the appended claims.

What is claimed is:

1. A method of assuring an advertiser that at least one user has attentively consumed an ad used to pay for on-line content, the on-line content being accessible over a network, comprising the steps of:
presenting at least one ad for consumption by the user at at least one computerized user device, the computerized user device being communicably coupled to the network;
detecting at least one condition associated with the user's consumption of the ad at the computerized user device; and
at least at some times, blocking or at least partially inhibiting one or both of:
(i) presentation of the ad for consumption by the user at the computerized user device; and
(ii) user access to at least one item of value associated with on-line content over the network at the computerized user device,
based at least on the condition associated with the user's consumption of the ad.

2. The method of claim 1 wherein the item of value corresponds to one or more of the on-line content, an access right to the on-line content, one or more coupons, a predetermined monetary amount, and a predetermined amount of virtual currency.

3. The method of claim 1 wherein the computerized user device includes at least one display, wherein the presenting of the ad comprises presenting the ad in association with a first one of a plurality of graphical display windows on the display, and wherein the detecting of the condition associated with the user's consumption of the ad comprises detecting a change of focus from the first one of the plurality of graphical display windows to a second one of the plurality of graphical display windows.

4. The method of claim 1 wherein the computerized user device includes at least one display, wherein the presenting of the ad comprises presenting the ad in association with a graphical display window on the display, and wherein the detecting of the condition associated with the user's consumption of the ad comprises detecting a minimization of a size of the graphical display window.

5. The method of claim 1 wherein the computerized user device includes at least one display, wherein the presenting of the ad comprises presenting the ad in association with a web page on the display, the web page corresponding to a first one of a plurality of tabs associated with a browser application executing on the computerized user device, and wherein the detecting of the condition associated with the user's consumption of the ad comprises detecting a selection of a second one of the plurality of tabs associated with the browser application.

6. The method of claim 1 wherein the computerized user device includes at least one display, wherein the presenting of the ad comprises presenting the ad in association with a graphical display window on the display, and wherein the detecting of the condition associated with the user's consumption of the ad comprises detecting a change in a size of the graphical display window.

7. The method of claim 6 wherein the ad is generated by an ad player application executing on the computerized user device, and wherein the detecting of the condition associated with the user's consumption of the ad comprises detecting a change in the size of the graphical display window below a minimum resolution of the ad player application.

8. The method of claim 1 wherein the computerized user device includes at least one display, wherein the presenting of the ad comprises presenting the ad in association with a graphical display window on the display, and wherein the detecting of the condition associated with the user's consumption of the ad comprises detecting a dragging of at least a portion of the graphical display window outside a visible region of the display.

9. The method of claim 1 wherein the computerized user device includes at least one speaker, wherein the presenting of the ad comprises presenting audible sound associated with the ad through the speaker, and wherein the detecting of the condition associated with the user's consumption of the ad comprises detecting a lowering of volume of the audible sound presented through the speaker.

10. The method of claim 1 wherein the computerized user device includes at least one camera, the camera having an associated field of view, and wherein the detecting of the condition associated with the user's consumption of the ad comprises detecting that no user is inside a region of the field of view of the camera from which the ad can be consumed.

11. The method of claim 1 wherein the computerized user device includes at least one display and at least one camera, and wherein the detecting of the condition associated with the user's consumption of the ad comprises detecting, using the camera, that no user is looking at the display.

12. The method of claim 1 wherein the computerized user device includes at least one microphone and at least one speaker, wherein the presenting of the ad comprises presenting audible sound associated with the ad through the speaker, and wherein the detecting of the condition associated with the user's consumption of the ad comprises detecting, using the microphone, a level of ambient noise above a predetermined threshold, the level of ambient noise being likely to interfere with user understanding of the audible sound of the ad presented through the speaker.

13. The method of claim 1 further comprising:
responsive to the detecting of the condition associated with the user's consumption of the ad, the condition being suggestive of user inattentiveness, presenting at least one message to the user by the computerized user device, the message requesting the user to perform at least one specified action detectable by the computerized user device.

14. The method of claim 13 wherein the presenting of the message to the user comprises presenting the message multiple times separated by a predetermined time interval.

15. The method of claim 14 further comprising:
in the event the specified action of the user is not detected at the computerized user device within a predetermined time period, decreasing the predetermined time interval by a specified amount.

16. The method of claim 13 further comprising:
in the event the specified action of the user is detected at the computerized user device within a predetermined time period, increasing the predetermined time interval by a specified amount.

17. The method of claim 1 further comprising:
reporting, by the computerized user device, the condition associated with the user's consumption of the ad to an ad charging server, for use in determining a monetary amount to be charged to an advertiser.

18. A system for assuring an advertiser that at least one user has attentively consumed an ad used to pay for on-line content, the on-line content being accessible over a network, comprising:
at least one computerized user device communicably coupled to the network, the computerized user device being operative:
to present at least one ad for consumption by the user at the computerized user device;
to detect at least one condition associated with the user's consumption of the ad at the computerized user device; and
at least at some times, to block or at least partially inhibit one or both of:
(i) presentation of the ad for consumption by the user at the computerized user device; and
(ii) user access to at least one item of value associated with on-line content over the network at the computerized user device,
based at least on the condition associated with the user's consumption of the ad.

19. The system of claim 18 wherein the item of value corresponds to one or more of the on-line content, an access right to the on-line content, one or more coupons, a predetermined monetary amount, and a predetermined amount of virtual currency.

20. The system of claim 18 further comprising:
an ad charging server communicably coupled to the network,
wherein the computerized user device is further operative to send a report of the condition associated with the user's consumption of the ad over the network to the ad charging server, and
wherein the ad charging server is operative to determine an amount to charge an advertiser based on the report of the condition associated with the user's consumption of the ad.

21. The system of claim 18 further comprising:
an ad publishing server communicably coupled to the network,
wherein the ad publishing server is operative to send the ad over the network to the computerized user device.

22. A system for assuring an advertiser that a user has attentively consumed an ad used to pay for on-line content, the on-line content being accessible over a network, comprising:
at least one computerized user device communicably coupled to the network; and
an external server communicably coupled to the network, wherein the computerized user device is operative:
to present at least one ad for consumption by the user at the computerized user device, and
wherein the external server is operative:
to detect at least one condition associated with the user's consumption of the ad at the computerized user device; and
at least at some times, to block or at least partially inhibit user access to at least one item of value associated with on-line content over the network based at least on the condition associated with the user's consumption of the ad.

23. The system of claim 22 wherein the item of value corresponds to one or more of the on-line content, an access right to the on-line content, one or more coupons, a predetermined monetary amount, and a predetermined amount of virtual currency.
